(19) United States
(12) Patent Application Publication
(10) Pub. No.: US 2022/0293019 A1
(43) Pub. Date: Sep. 15, 2022

(54) FLAG HOLDER FOR SPORTS FAN EXPRESSION

(71) Applicant: Bill Ray Robinson, Zephyrhills, FL (US)

(72) Inventor: Bill Ray Robinson, Zephyrhills, FL (US)

(21) Appl. No.: 17/249,778

(22) Filed: Mar. 12, 2021

(51) Int. Cl. G09F 17/00

(52) U.S. Cl. CPC G09F 17/00; G09F 2017/0066

(57) ABSTRACT

A flag holder and flag display are disclosed. The flag holder includes an upright flag staff with a plurality of ground penetrating stakes extend from the bottom end. A flag holding rod has a proximal end and a distal end. A coupling is defined at the proximal end that is configured for rotation of the flag holding rod about the upright flag staff. The distal end is configured to carry a top edge of a flag in a fully unfurled condition. A stop assembly is coupled to the upright flag staff to rotationally support the flag holding rod at a desired elevation on the flag staff. A sleeve on a vertical edge of the flag may be rotationally carried on the top end of the flag staff.

### BACKGROUND OF THE INVENTION

The present invention relates to flag holders, and more particularly to flag holders for sports and fan appreciation expression.

Sports fans often like to express their appreciation for their favorite team during a particular sports season or during games or matches involving their favorite team. These fans may display flags, pennants, or banners for their sports team, school, club, or other athletic organizations. Often these are full size flags hung from conventional flag poles, windows, or other parts of their home.

Currently, sports fans do not have a flag stand for them to proudly display smaller flags and pennants, on the order of 11″ by 14″ in size. Conventional sticks or rods are unsuited to these smaller flags and pennants since the limited surface area of the flags are not amenable to waving the flag in zero or limited wind conditions.

As can be seen, there is a need for an improved flag holder that retains a flag in a fully unfurled condition, while permitting the flat to rotate in response to a wind condition.

### SUMMARY OF THE INVENTION

In one aspect of the present invention, a flag holder is disclosed. The flag holder includes an upright flag staff having a top end and a bottom end. A plurality of ground penetrating stakes extend from the bottom end. A flag holding rod has a proximal end and a distal end. A coupling is defined at the proximal end that is configured for rotation of the flag holding rod about the upright flag staff. The distal end is configured to carry a top edge of a flag in a fully unfurled condition. A stop assembly is coupled to the upright flag staff to rotationally support the flag holding rod at a desired elevation on the flag staff.

In other aspects of the invention, a flag display is disclosed. The flag display includes an upright flag staff having a top end and a bottom end. A plurality of ground penetrating stakes extending from the bottom end. A flag has a first sleeve defined along a vertical edge of the flag. The first sleeve is dimensioned to rotationally receive the top end of the flag staff therethrough. A second sleeve is defined along a top edge of the flag. A flag holding rod has a proximal end and a distal end. A coupling at the proximal end is configured for rotation of the flag holding rod about the upright flag staff. The distal end is received in the second sleeve to support the flag in a fully unfurled condition. A stop assembly is coupled to the upright flag staff to rotationally support the flag holding rod at a desired elevation on the flag staff.

These and other features, aspects and advantages of the present invention will become better understood with reference to the following drawings, description and claims.

### BRIEF DESCRIPTION OF THE DRAWINGS

FIG. 1 is a perspective view of the invention in use;

FIG. 2 is a perspective view of the invention;

FIG. 3 is an exploded view of the invention;

FIG. 4 is a detailed exploded view of the invention;

FIG. 5 is a section view of the invention, taken along line 5-5 of FIG. 1;

FIG. 6 is a detailed section view of the invention; and

FIG. 7 is a top view of the invention showing rotation.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an improved flag holding apparatus and flag for displaying a sports team affiliation or other message carried by the flag with the flag suspended in a fully unfurled condition.

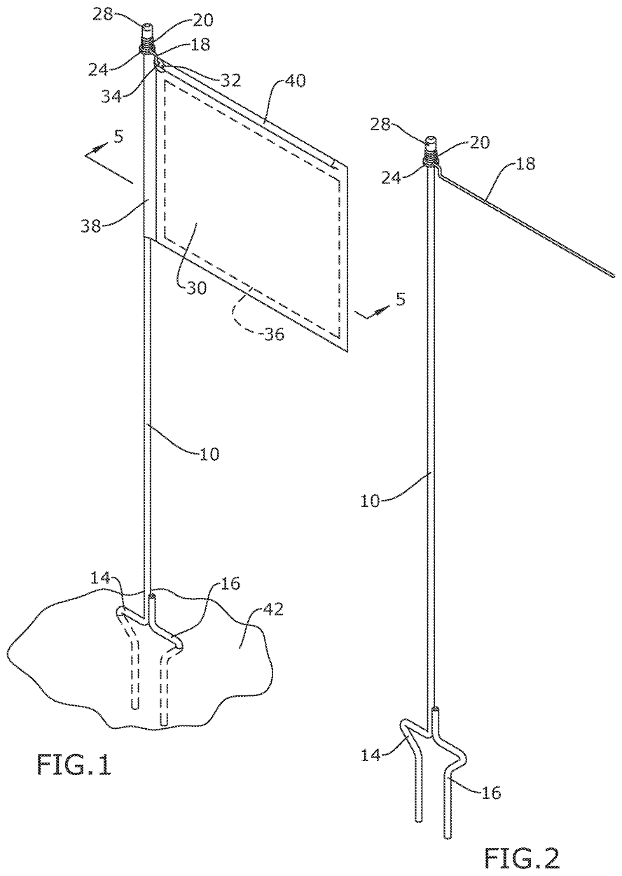

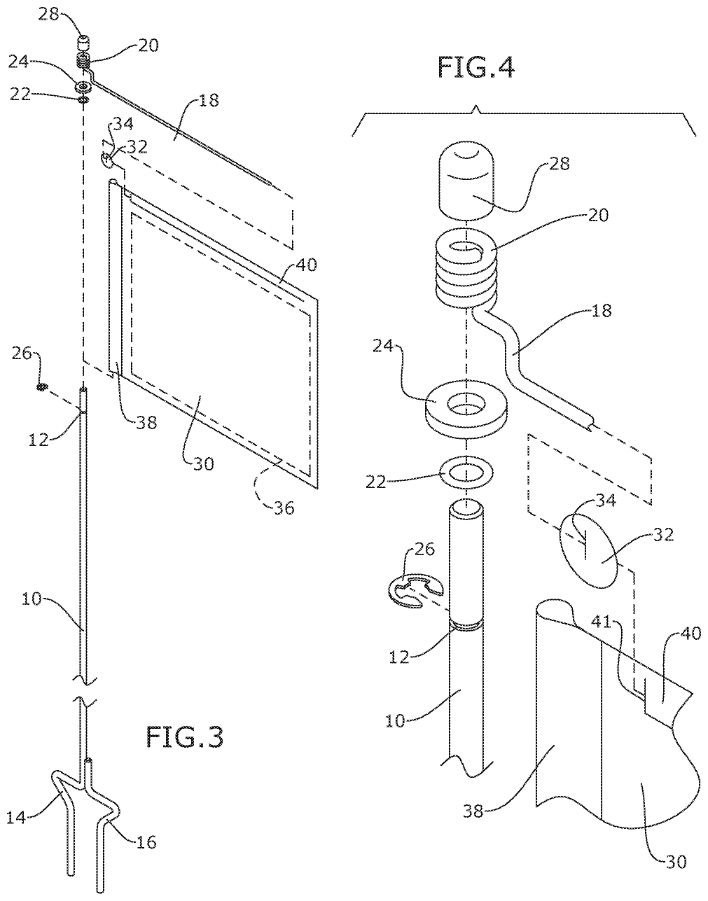

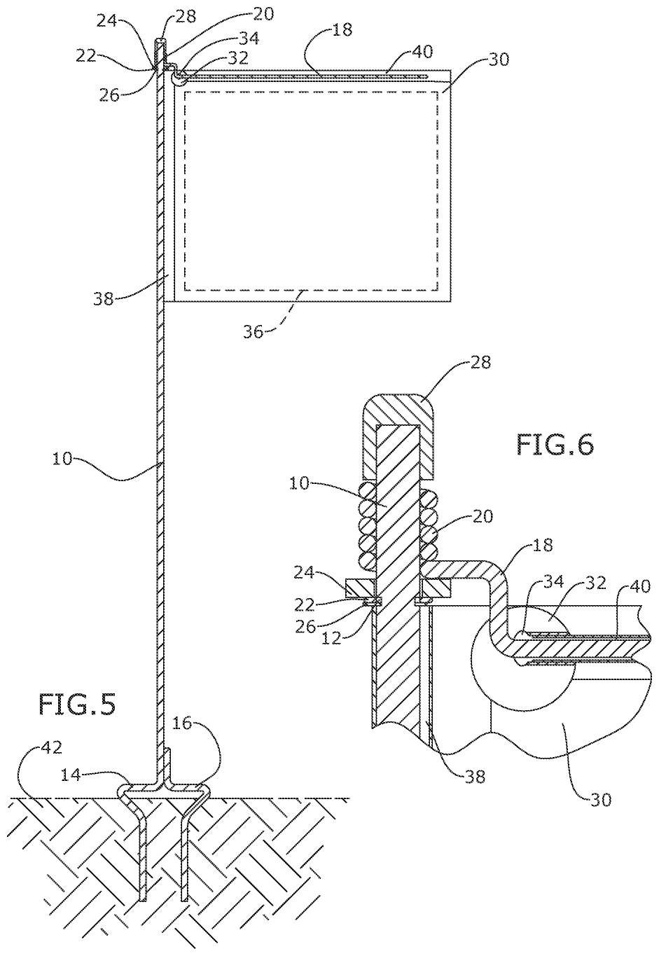

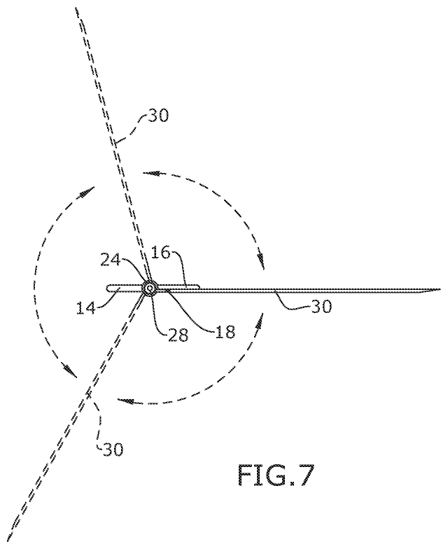

A flag holder of the present invention is shown in reference to the drawings of FIGS. 1-7. The flag holder includes an upright flag staff 10 having a top end and a bottom end. The bottom end includes a plurality of ground 42 penetrating stakes 14, 16 protruding from the bottom end in a spaced apart relation and oriented for penetrate a ground surface 42 in a parallel alignment.

A flag 30 rotationally attached to the top end of the flag staff 10. The flag 30 has a first sleeve 38 aligned along a vertical edge of the flag 30 and a second sleeve 40 aligned along a top horizontal edge of the flag 30. The top end of the flag staff 10 may be carried through the first sleeve 38. A proximal end of a flag holding rod 18 is pivotally coupled to the top end of the flag staff 10. The flag holding rod 18 extends laterally from its connection with the flag staff 10. A distal length of the flag holding rod is received an opening 41 in the second sleeve 40 of the flag 30 and supports the flag 30 in a fully unfurled condition so that indicia 36 identifying the team may be visible.

The proximal end of the flag holding rod 18 is supported by a vertical stop assembly to position the flag 30 at a desired vertical elevation on the flag staff 10. The proximal end of the flag holding rod 18 has a coupling with a bore that is dimensioned to receive the top end of the flag staff 10. To provide for a flexing of the flag holding rod 18 to prevent damage to either the flag holding rod 18 or the flag staff 10, the coupling may include a plurality of spring winds 20. The flag holding rod 18 may be formed of a spring steel, a thermo plastic, or other suitable material that provides sufficient rigidity to support the flag 30 in the fully unfurled condition while having sufficient flexibility to bend in response to a strong wind condition or contact of the slag holding rod 18 with other objects.

In the non-limiting embodiment shown, the vertical stop assembly may include a washer 24 that provides a low friction rotational surface to carry the coupling. The washer 24 is supported by a spring clip 26 that engages with the top end of the flag staff 10 to support the washer 24, and flag holding rod 18, and flag 30 at the desired elevation on the flag staff 10. The flag staff 10 may also have an annular groove dimensioned to receive the spring clip 26. In some embodiments, an O-ring 22 may be interposed between the washer 24 and the spring clip 26.

Once the flag 10 and flag holding rod 18 have been coupled to the flag staff 10, a retaining cap 28 may be applied to the tip of the flag staff 10 to retain the flag holding rod 18 with the flag staff 10. When supported on the flag staff 10, the flag holding rod 18 and flag 30 carried thereon, may rotate in a 360 degree arc about the flag staff 10. In this manner, the user can position the flag 30 in a desired display orientation. In windy conditions, the flag 30 carried on the holding rod 18 may weathervane in response to a wind condition.

While described in the context of displaying a sports flag, the present invention is also amenable to use with flags carrying a holiday decorative motif, a baby announcement, a graduation event, a political campaign, a yard sale, and the like.

It should be understood, of course, that the foregoing relates to exemplary embodiments of the invention and that modifications may be made without departing from the spirit and scope of the invention as set forth in the following claims.

What is claimed is:

1. A flag holder comprising:
an upright flag staff having a top end and a bottom end;
a plurality of ground penetrating stakes extending from the bottom end;
a flag holding rod having a proximal end and a distal end, a coupling at the proximal end configured for rotation of the flag holding rod about the upright flag staff, the distal end configured to carry a top edge of a flag in a fully unfurled condition; and
a stop assembly coupled to the upright flag staff to rotationally support the flag holding rod at a desired elevation on the upright flag staff.

2. The flag holder of claim 1, the coupling further comprising:
a plurality spring winds defined in proximal end of the flag holding rod defining an axial bore dimensioned to receive the top end of the upright flag staff.

3. The flag holder of claim 2, the stop assembly further comprising:
a spring clip resiliently coupled to the upright flag staff.

4. The flag holder of claim 3, further comprising:
a washer disposed on the upright flag staff between the spring clip and the coupling.

5. The flag holder of claim 4, further comprising:
an O-ring interposed between the spring clip and the washer.

6. The flag holder of claim 5, further comprising:
a retaining cap configured to retain the flag holding rod on the upright flag staff.

7. A flag display comprising:
an upright flag staff having a top end and a bottom end;
a plurality of ground penetrating stakes extending from the bottom end;
a flag having a first sleeve defined along a vertical edge of the flag, the first sleeve dimensioned to receive the top end of the upright flag staff therethrough, and a second sleeve defined along a top edge of the flag;
a flag holding rod having a proximal end and a distal end, a coupling at the proximal end configured for rotation of the flag holding rod about the upright flag staff, the distal end configured to be received in the second sleeve to support the flag in a fully unfurled condition; and
a stop assembly coupled to the upright flag staff to rotationally support the flag holding rod at a desired elevation on the upright flag staff.

8. The flag display of claim 7, the coupling further comprising:
a plurality spring winds defined at the proximal end of the flag holding rod, the plurality of spring winds defining an axial bore dimensioned to receive the top end of the upright flag staff.

9. The flag display of claim 8, the stop assembly further comprising:
a spring clip resiliently coupled to the upright flag staff.

10. The flag display of claim 9, further comprising:
a washer disposed on the upright flag staff between the spring clip and the coupling.

11. The flag display of claim 10, further comprising:
an O-ring interposed between the spring clip and the washer.

12. The flag display of claim 11, further comprising:
a retaining cap configured to retain the flag holding rod on the upright flag staff.
